(19) United States
(12) Patent Application Publication
(10) Pub. No.: US 2026/0018911 A1
(43) Pub. Date: Jan. 15, 2026

(54) BATTERY PROTECTION CIRCUIT AND METHOD FOR HAZARDOUS ENVIRONMENTS

(71) Applicant: MOTOROLA SOLUTIONS, INC., CHICAGO, IL (US)

(72) Inventors: MUHAMAD RIDZUAN AZIZAN, BALING (MY); CHEN KOK YEOH, BUKIT MERTAJAM (MY); MACWIEN KRISHNAMURTHI, SHAH ALAM (MY); KOW CHEE CHONG, BAYAN LEPAS (MY)

(21) Appl. No.: 18/768,036

(22) Filed: Jul. 10, 2024

(51) Int. Cl. H02J 7/00; H01M 50/102; H02J 7/34

(52) U.S. Cl. CPC H02J 7/00304; H01M 50/102; H02J 7/00308; H02J 7/345; H01M 2220/30; H02J 2207/50

(57) ABSTRACT

A clamshell battery for a portable radio provides protection from excessive current for operation under HazLoc environments. Three loops of current protection are provided to protect two energy storage elements (cells and bulk capacitor). The first current loop blocks current from one cell pack from charging cells in another cell pack, and also constrains cell pack discharge current to be below a safety threshold. The second loop blocks a reverse current loop from the bulk capacitor to the cell pack, and constrains a high forward current loop from the cell pack to the bulk capacitor. The third loop blocks excessive forward current looping from bulk capacitor to the battery, and constrains high reverse current looping from radio device capacitors/load to the bulk capacitor.

### BACKGROUND OF THE INVENTION

A battery holder is a device that enables the use of non-rechargeable batteries to power a portable radio during emergencies, such as power outages or fire related emergencies. Clamshell battery holders may hold numerous non-rechargeable cells which may be configured in a variety of cell combinations, different cell sizes, and different non-rechargeable cell chemistries. Clamshell battery holders may also include a large bulk capacitance.

The importance of avoiding spark conditions is particularly important when operating battery powered portable radios under hazardous environments. Intermittent battery contacts, individual removal/replacement of battery cells which may incur dust causing shorts, and the large bulk capacitance may contribute to potential spark conditions.

Accordingly, there is a need for an improved clamshell battery holder for a portable radio for hazardous environments.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a clamshell battery having a battery protection circuit formed in accordance with some embodiments.

FIG. 2 is a schematic block diagram of the clamshell battery of FIG. 1 in accordance with some embodiments.

FIG. 3 shows a different views of the clamshell battery with and without the portable radio in accordance with some embodiments.

FIG. 4 shows different views of non-rechargeable battery cells of the clamshell battery in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

The clamshell battery holder to be described here may use two large storage elements, one storage element being the cell portion and the other storage element being a bulk capacitor portion. The two large storage elements (cells and bulk capacitor) may generate high forward and reverse current loops within the battery circuitry when both elements are at different potentials. If the loop paths suddenly incur an intermittent connection, such as from a spring contact bounce, then a spark may be generated at the point of intermittence.

The spark scenario may be aggravated by additional factors such as individually replaceable cells, where a customer may possibly replace cells with a different cell type or different cell orientation. The spark scenario may be further aggravated by the use of high capacitance bulk capacitors, where the capacitance is greater than the allowable system capacitance. For example, a bulk capacitance of greater than 1400 microfarad (μF) may be used under conditions designed for a maximum of 380 F. The maximum permitted capacitance of 380uf, for example, applies to an 8.4V system with voltage safety factor provided by the International Electrotechnical Commission for Explosive Atmospheres (IECEx). When the total capacitance of a system product (e.g. device, battery, remote speaker microphone) exceeds the allowable capacitance (per the clamshell battery's bulk capacitance of 1400 μF) of approximately 380 μF for the 8.4Vdc system, methods and circuits incorporated as provided in this application ensure that the effective system's allowable capacitance of 380 μF for a 8.4Vdc system is curtailed and maintained, such that ignition due to sparking/arcing are inhibited in a hazardous location (HazLoc).

Briefly, there is provided herein, a clamshell battery for a portable radio. The clamshell battery manages charge/discharge (forward/reverse) current loops for a battery pack having at least two charge storage elements (cell packs and bulk capacitor) to prevent spark ignition for hazardous location (HazLoc) environments. The clamshell battery comprises three parallel circuits which operate to block unwanted current loops and manage constraints of wanted current loops to avoid conditions that might otherwise cause sparking.

A first current loop protection is directed to the cell pack, the cell pack comprising first and second series coupled cell packs, wherein the first and second cell packs are coupled in parallel at a negative terminal. The first current loop protection (1) blocks the first series coupled cell pack from charging the parallel second series cell pack, and vice versa, due to voltage imbalance or internal cell shorts by applying, preferably three, unidirectional circuits in a series connection with the cell packs. The first current loop protection (2) constrains cell pack discharge current to be below a safety threshold by applying first and second current limit circuits in series between the unidirectional circuits and the first and second cell packs.

A second current loop protection is directed to the cell pack and bulk capacitor. The second current loop protection blocks a reverse current loop from the bulk capacitor to the cell pack by adding a third unidirectional circuit in series between the combination of first and second unidirectional circuits and the bulk capacitor. The second current loop protection constrains a high forward current loop from the cell pack to the bulk capacitor by adding a third current limiter circuit having a parallel coupled fourth unidirectional circuit (formed of series coupled diodes), the parallel coupling being in series with the bulk capacitor.

A third current loop is directed to the bulk capacitor and the battery output. The third current loop protection blocks excessive forward current looping from the bulk capacitors to the battery output by adding a fourth current limiter circuit and high speed current limit circuit in the current loop path to the device caps/load. The third current loop provides protection that constrains high reverse current looping from the device caps/load to the bulk capacitor by applying the third current limiter that is parallel coupled to the fourth unidirectional circuit in series with the bulk capacitor. The fourth current limit circuit constrains forward current of the third current loop to a predetermined threshold (for example, a threshold of approximately 19A) while the high speed current limit circuit dampens excessive energy for a predetermined time period (for example, approximately 2 μs).

The drawings and description for this application may use abbreviations of 1^{st}, 2^{nd}, 3^{rd}, and 4^{th} to refer to first, second, third and fourth.

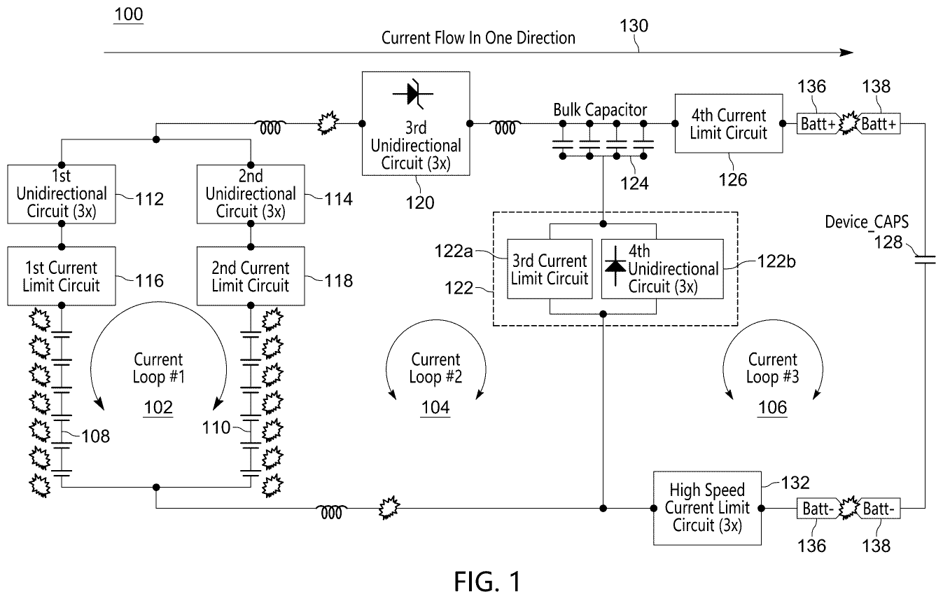

FIG. 1 is a schematic block diagram of a clamshell battery 100 for a portable radio, the clamshell battery being formed in accordance with some embodiments. The clam shell battery 100 resides within a battery clamshell holder (shown in later figures). Clamshell battery 100 comprises circuitry that manages sequential operation of a first (1^{st}) current loop 102, a second (2^{nd}) current loop 104 and a third (3^{rd}) current loop 106. The clamshell battery 100 addresses potential areas of sparking which may occur as a result of spring contact vibration, removal/insertion of cells, as well as from parasitic inductance (for example, shown as L1, L2, L3) on the current loop paths.

The sequential operation of first current loop 102, second current loop 104 and third current loop 106 is used to manage charge/discharge (forward/reverse) current loops for the clamshell battery 100 having at least two charge storage elements to prevent spark ignition for HazLoc environment. The two charge storage elements, of clamshell battery 100 comprise a battery cell pack of primary (non-rechargeable) cells 108, 110 and a bulk capacitor 124.

First current loop 102 comprises the first cell pack 108 formed of a plurality of series coupled primary cells, and the second cell pack 110, also formed of a plurality of series coupled primary cells. Primary cells are considered disposable, replaceable, non-rechargeable cells. Each cell pack 108, 110 has a respective in positive terminal and negative terminal. The two cell packs are parallel coupled at their respective negative terminals.

The first loop 102 further comprises a first (1^{st}) unidirectional circuit 112 and a first (1^{st}) current limit circuit 116 coupled in series to the positive terminal of the first cell pack 108. The first loop 102 further comprises a second unidirectional circuit 114 and a second (2^{nd}) current limit circuit 118 coupled in series to the positive terminal of the second cell pack 110.

The series coupled first unidirectional circuit 112 and first current limit circuit 116 provide a first current blocking path to the first cell pack 108. The series coupled second unidirectional circuit 114 and second current limit circuit 118 provide a second current blocking path to the second cell pack 110. The first and second current blocking paths prevent the first cell pack 108 from charging the second cell pack 110 (and vice versa).

The first unidirectional circuit 112 and second unidirectional circuit 114 each preferably comprise three redundant active circuits to prevent current from flowing into their respective first and second cell packs 108, 110. Examples of active components include diodes, transistors, ICs, to name a few. The first current limit circuit 116 and second current limit circuit 118 are configured to constrain cell discharge current within a predetermined current threshold suitable for HazLoc environments. This controlled cell discharge advantageously enables slow charging of the bulk capacitors 124.

The first current loop 102 may be summarized as comprising a series coupled first unidirectional circuit 112, first current limit circuit 116 and first cell pack 108 being coupled in parallel with series coupled second unidirectional circuit 114, second current limit circuit 118 and the second battery cell pack 110.

The second current loop 104 is formed of the parallel coupled cell packs 108, 110 which are further series coupled to bulk capacitor 124. The second loop 104 includes a third (3rd) unidirectional circuit 120, in series with the bulk capacitor 124 (positive), to block reverse current from the bulk capacitor back to the first and second cell packs 108, 110. The second loop 104 also includes a parallel coupling 122 formed of third (3rd) current limit 122a (resistors) and fourth (4th) unidirectional circuit 122b (diodes). The parallel coupling 122 being in series with the bulk capacitor 124 (negative) constrains high forward loop current from the first and second cell packs 108, 110 to the bulk capacitor 124.

The second current loop 104 may be summarized as a series coupled third unidirectional circuit 120, bulk capacitor 124, and parallel coupling 122 formed of third current limit 122a and 4th unidirectional circuit 122b coupled in parallel to the first current loop (102).

The third current loop 106 is formed of series coupled bulk capacitor 124 and device capacitors 128, the device capacitors being coupled via (+/−) battery interface contacts 136 to corresponding (+/−) device contacts 138. The series coupled bulk capacitor 124 and device capacitive load 128 are coupled in parallel to the first and second cell packs 108, 110.

The third current loop 106 includes a fourth (4th) current limit circuit 126. The fourth current limit circuit 126 may comprise, for example, a fixed resistor or dynamic resistor coupled in series between the bulk capacitor 124 and device load 128 via the positive terminal of battery interface contacts 136. The fourth current limit circuit 126 limits high current from the bulk capacitor 124 to the device capacitive load 128 or vice versa. Hence, the bulk capacitor 124 coupled in series with the parallel circuit 122 has been configured for slow charge (via third current limit circuit 122a) and fast discharge (via 4th unidirectional circuit 122b), unlike typical battery pack designs configured for fast charge and fast discharge.

The third current loop 106 includes a high speed current limit circuit 132 coupled between the negative contact of battery interface contacts 136 and the negative terminal of the first and second cell packs 108, 110, and to the negative terminal of the coupled parallel circuit of 122 which are third current limit circuit 122a and fourth unidirectional circuit 122b. The high speed current limit circuit 132 is configured as a high speed current protection circuit that responds to high current within a predetermined time, for example two microseconds. The high speed current limit circuit 132 detects and blocks excessive forward current from bulk capacitor 124 and cell packs 108, 110 through the unidirectional current path 130 to a positive terminal of battery interface contacts 136, 138. The device capacitors 128 return to a negative terminal of battery interface contacts 136, 138 back to cells 108, 110 and the parallel circuit 122 negative terminals.

The management of current at the cell packs 108, 110, bulk capacitor 124, and device capacitive load 128 is controlled via the first, second and third current loops 102, 104, 106. Operationally, the second current loop 104 manages two current flows. The two current flows managed by the second current loop 104 being (1) at the cell packs 108, 110 and (2) at the bulk capacitor 124 and device capacitive load 128. Operationally, the third current loop 106 manages two current flows. The two current flows managed by the third loop 106 being (1) at the cell packs 108, 110 and bulk capacitor 124 and (2) at the device capacitive load 128. The maximum charge and discharge current of each current loop may be determined based on a sum current from each of the cell packs 108, 110, bulk capacitor 124) and device capacitors 128.

The three current loops 102, 104, 106 advantageously provide for a current flow in one direction, referred to as a unidirectional current path 130. The unidirectional current path 130 charges the bulk capacitor 124 and sources the device capacitive load 128 within current constraints which avoid sparking in a HazLoc environment.

While the first, second, third, and fourth current limit circuits 116, 118, 122a, and 126 may be configured using passive and/or active components, the passive design (e.g. resistors, capacitors, inductors to name a few) is preferred for reasons of low cost, simplicity and space. Passive components store or maintain energy in the form of voltage or current, and can consume, store, or release supplied electric energy. The high speed current limit circuit 132 is preferably configured as an active circuit for reasons of efficiency, low voltage drop, low power dissipation and lower thermal release compared to passive circuitry. Examples of active components include diodes, transistors, ICs, current and voltage sources.

Accordingly, the clamshell battery 100 provides circuitry that enables the first current loop 102, second current loop 104, and third current loop 106 to form one unidirectional current path 130 to the device capacitive load 128. The clamshell battery 100 advantageously provides triple protection via the active and passive circuitry within the three loops. In the first loop 102, the combination of primary cells 108, unidirectional circuit 112, and current limit circuit 116 are connected in series to form a first protected unidirectional cell discharge path that allows multiple primary cell packs, such as primary cells 110, unidirectional circuit 114, and current limit circuit 118) to be connected in parallel for HazLoc environments. The use of active and passive circuitry within the three loops provides for a triple redundancy circuit which meets the HazLoc requirement of minimum of two faults cases.

The unidirectional current path 130 protects against intermittent connections, such as caused by vibrations, and cell removal/insertion, battery pack and device removal/insertion which might otherwise lead to sparking. The current limit circuit provided by the three loops 102, 104, 106 stops excessive current caused from cell voltage imbalance and/or cell internal/external shorting.

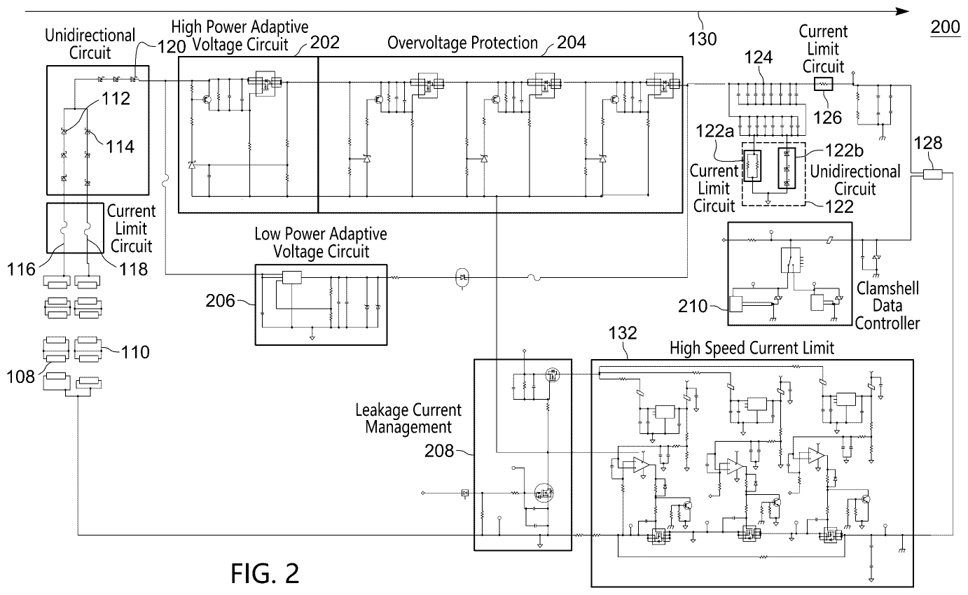

FIG. 2 is a schematic block diagram used to implement the clamshell battery 100 of FIG. 1 in accordance with some embodiments. Circuitry 200 includes battery cell packs 108, 110 respectively coupled to first and second current constraint components (for example: fuse, resistor) of current limit circuits 116, 118. The parallel unidirectional circuits 112, 114 each comprise triple forward biased diodes coupled in series. The diodes of the parallel unidirectional circuits 112, 114 are further coupled in series with triple forward biased diodes of unidirectional circuit 120.

The circuitry 200 further comprises a high power adaptive voltage circuit 202 and overvoltage protection circuit 204 coupled in series between the third unidirectional circuit 120 and bulk capacitor 124. The bulk capacitor 124 comprises a plurality of parallel coupled capacitors. The circuitry 200 further comprises a low power adaptive voltage circuit 206 coupled in parallel with the series coupled high power adaptive voltage circuit 202 and overvoltage protection circuit 204.

The high power adaptive voltage circuit 202 is formed of, for example, a PNP transistor biased by pull-up resistors and blocking diode to open and close a FET. The high power adaptive voltage circuit 202 manages the voltage regulation either boosting or damping the input voltage to comply with HazLoc requirement and presents voltage signal to the overvoltage protection circuit 204.

The overvoltage protection circuit 204 provides triple redundancy overvoltage protection using, for example, PNP transistors biased via voltage dividers and blocking diodes to control opening and closing FETs along the unidirectional current path 130. The high power adaptive voltage circuit 202 controls voltage sources to bulk capacitor 124 and device capacitors 128 via battery interface contacts 136, 138, for example by blocking the cell pack voltage and/or dampening the voltage spikes caused by sparking conditions on the unidirectional current path 130.

The low power adaptive voltage circuit 206 comprises voltage dividers sensing, low voltage regulator IC, zeners, clamping diodes, fuses and blocking diodes. The low power adaptive voltage circuit 206 controls voltage sources, for example by boosting and/or dampening the cell pack voltage spikes caused by sparking conditions on the unidirectional current path 130.

Leakage management circuit 208 controls leakage current of high power adaptive voltage circuit 202, over voltage protection circuit 204, or any other leakage currents. The leakage management circuit 208 includes switchable controlled FETs to control input voltage source to the high speed current limit 132.

FIG. 2 also shows the high speed current limit circuit 132 which comprises a bank of triple redundancy current limiting via three series current limiting circuits including voltage reference IC, voltage comparator, latch circuit components, time constant circuits and FETs.

As shown in FIG. 2, the parallel coupling 122 (parallel combination of third current limit 122a and fourth unidirectional circuit 122b) is coupled in series between the bulk capacitors 124 and negative cell pack terminal. The third current limit circuit 122a comprises at least one resistor coupled in parallel to fourth unidirectional circuit 122b which preferably comprises three series coupled blocking diodes. The resistors of the third current limit circuit 122a serve to slow the charging of the bulk capacitor 124 from forward current of second current loop 104, while the diodes of unidirectional circuit 122b allow fast discharging of bulk capacitor 124 from forward current of third current loop 106. The charging of the bulk capacitor 124 by the current from the cell packs 108, 110, flows via the first and second current limit circuits 116, 118, the first and second unidirectional circuits 112, 114 and then through the third unidirectional circuit 120 to bulk capacitor 124. This current flows in the return path through the third current limit circuit 122a and back to the negative terminal of cells packs 108 & 110. The discharging of current from the bulk capacitor 124 flows through the 4th current limit 126, then through the device capacitor 128 via interface contacts 136 and!38. This current return path then flows back to the battery cells via high speed current limit circuit 132 and through the 4th unidirectional circuit 122b, thus returning back to the bulk capacitor 124.

As shown in FIG. 2, a clamshell data controller 210 further comprises memory ICs and switch circuitry. The clamshell data controller operates to manage the battery data per the type of cells being used.

As shown in FIG. 2, the 4th current limit circuit 126 comprises current constraint components, for example a resistor which is coupled to one of the terminals of the bulk capacitor 124. The resistor dampens current from the bulk capacitor 124 and cell packs 108 & 110 to the device capacitive load 128.

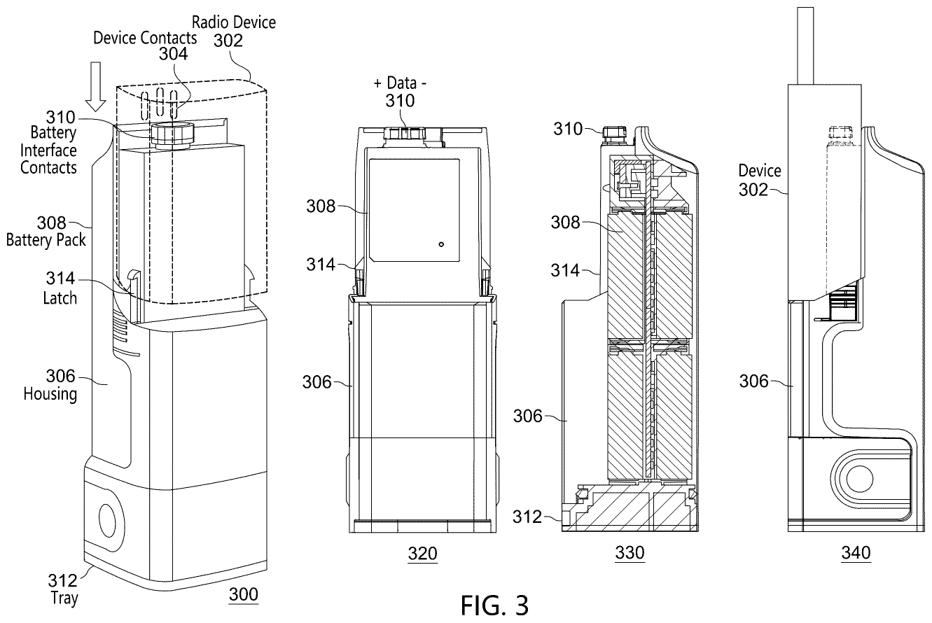

FIG. 3 shows various views 300, 320, 330, 340 of a clamshell battery holder, with and without a portable radio attached thereto, in accordance with some embodiments. View 300 shows a partial view (dashed lines) of a portable radio device 302, such as a portable public safety radio, with radio device contacts 304 being inserted and coupled into a clamshell housing 306. A clamshell battery pack 308, formed in accordance with embodiments as previously described at FIG. 1, is coupled within the clamshell housing 306 via a tray 312. The tray 312 with clamshell battery pack 308 mounted thereo are insertable to, and removable from, a bottom opening of claimshell housing 306. The clamshell housing 306 includes battery interface contacts 310 for alignment with corresponding radio device contacts 304.

The clamshell housing 306 includes latches 314 for retaining the portable radio device 302 within at least some portion of the clamshell housing 306. The radio device contacts 304 thus align with the battery interface contacts 310. The radio device contacts 304 correspond to device contacts 138 of FIG. 1, and battery interface contacts 310 correspond to battery contacts 136 of FIG. 1.

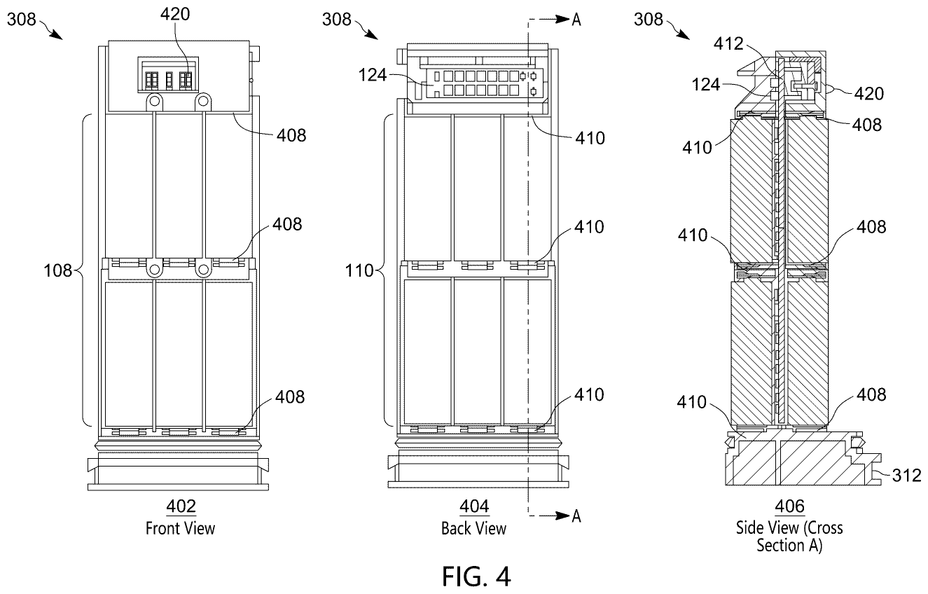

View 320 shows a front view of the clamshell housing 306 including battery interface contacts 310, latches 314, and general indication of internal clamshell battery pack 308. View 330 shows a side cut-away view of the clamshell housing 306 with clamshell battery pack 308 mounted therein. The clamshell battery pack 308 includes cells such as shown in FIG. 1, and which will be described in conjunction with FIG. 4. The cells of clamshell battery pack 308 are mounted to tray 312. View 340 shows a partially cut-away side view of the clamshell housing 306 with portable radio device 302 latched thereto.

FIG. 4 shows different views 402, 404, 406 of the clamshell battery pack 308 in accordance with some embodiments. View 402 is a front view of the clamshell battery pack 308. View 404 is a back view of the clamshell battery pack 308. View 406 is a side view of the clamshell battery pack 308.

The clamshell battery pack 308 includes a plurality of non-rechargeable cells 108, 110. The cells 108, 110 are mounted to tray 312. The clamshell battery pack is insertable to, and removable from, an opening in the base of the clamshell holder of FIG. 3 via the tray 312. The non-rechargeable cells 108, 110 are accessible for replacement when the clamshell battery pack 308 is removed from the clamshell holder.

The front view 402 shows the cells 108 with associated battery cell contacts 408, and battery pack interface spring contacts 420 (all areas which may be susceptible to sparking). The battery pack interface spring contacts 420 align with battery interface contacts 310 of clamshell of FIG. 3.

The back view 404 shows the cells 110 of FIG. 1 with associated battery cell contacts 410, and the bulk capacitor(s) 124 from FIG. 1 (all areas which may be prone to sparking). The cells 108 are coupled in parallel with cells 110 at a common negative terminal, as was described at FIG. 1.

The side view 406 shows the potential areas for sparking including bulk capacitors 124, front cell contacts 408, back cell contacts 410, and battery interface spring contacts 420. The circuitry described in FIG. 1 and FIG. 2 is located on a printed circuit board 412 sandwiched between the two sets of parallel coupled cell packs 108, 110. The potential areas for sparking have been beneficially addressed by the unidirectional circuits, current limiting circuits, controlled discharging of the cells, and controlled charging and discharging of the bulk capacitor 124 via the three current loops 102, 104, 106 of FIG. 1 which provide the unidirectional current path 130 as previously described.

Accordingly, the current limiting and management of current flow as described at FIG. 1 and FIG. 2 provides protection against sparking. Unlike typical battery pack designs configured for fast charge and fast discharge, the bulk capacitor(s) 124 coupled in series with the parallel coupling 122 has been configured for slow charge (via third current limit circuit 122a) and fast discharge (via fourth unidirectional circuit 122b). The spark protection provided by the three parallel loops of the clamshell battery negates sparking while individual, non-rechargeable cells are removed and replaced. The plurality of unidirectional circuits 112, 114, 120, 122b, current limit circuits 116, 118, 122a, and high speed current limit circuit 132 of clamshell battery 100 beneficially allow a portable radio device to operate safely within both HazLoc and non-HazLoc environments.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In this document, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one . . . ” and “one or more . . . ” language.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A clamshell battery for a portable radio, the clamshell battery comprising:
a first battery cell pack (108) formed of a plurality of a series coupled primary cells;
a second battery cell pack (110) formed of a plurality of series coupled primary cells, the first and second battery cell packs 108, 110) being parallel coupled at a negative terminal;
a first current loop (102) formed of:
a series coupled first unidirectional circuit (112), first current limit circuit (116) and the first battery cell pack (108) being coupled in parallel with a series coupled second unidirectional circuit (114), second current limit circuit (118) and the second battery cell pack (110);
a second current loop (104) formed of:
a series coupled third unidirectional circuit (120), bulk capacitor (124) and parallel coupling (122) formed of third current limit circuit (122a) and fourth unidirectional circuit (122b), the second current loop being coupled in parallel to the first current loop (102); and
a third current loop (106) formed of:
a series coupled fourth current limit circuit (126), device capacitive load (128) and high speed current limit circuit (132), the third current loop being coupled in parallel to the second current loop (104); and
the first current loop, the second current loop and the third current form a unidirectional current path (130) for discharging current from the first and second cell packs (108, 110) to the device capacitive load (128).

2. The clamshell battery of claim 1, wherein at the first current loop:
the first unidirectional circuit (112) blocks charging from the first cell pack (108) to the second cell pack (110);
the second unidirectional circuit (114) blocks charging from the second cell pack (110) to the first cell pack (108);
the first current limit circuit (116) constrains cell discharge current within a predetermined threshold; and
the second current limit circuit (118) constrains cell discharge current within the predetermined threshold.

3. The clamshell battery of claim 1, wherein at the second current loop:
the third unidirectional circuit (120) blocks reverse current from the bulk capacitor (124) to the first and second cell packs (108, 110);
the third current limit circuit (122a) constrains high forward current from the first and second cell packs (108, 110) to the bulk capacitor (124); and
the bulk capacitor (124) is charged over a predetermined time by the first and second battery cell packs (108, 110).

4. The clamshell battery of claim 1, wherein at the third current loop:
the fourth current limit circuit (126) detects and constrains excessive forward current from the bulk capacitor (124) to the device capacitive load (128) within a predetermined time;
the fourth current limit circuit (126) detects and constrains current from the device capacitive load (128) back to the bulk capacitor (124); and
the high speed current limit (132) blocks excessive discharge output current of the cell pack (108, 110) and bulk capacitor (124) exceeding a predetermined threshold through the unidirectional current path (130) within a predetermined time.

5. The clamshell battery of claim 1, wherein at the second current loop further comprises:
a high power adaptive voltage circuit (202) and overvoltage protection circuit (204) coupled in series between the third unidirectional circuit (120) and bulk capacitor (124); and
a low power adaptive voltage circuit (206) coupled in parallel with the series coupled high power adaptive voltage circuit (202) and overvoltage protection circuit (204).

6. The clamshell battery of claim 1, wherein the first, second, third and 4th unidirectional circuits (112, 114, 120, 122b) are each configured with three series coupled diodes.

7. The clamshell battery of claim 1, wherein the first, second, third and fourth current limit circuits (116,118,122a,126) are configured with passive components and the high speed current limit circuit (132) is configured with active components.

8. The clamshell battery of claim 1, wherein the high speed current limit circuit (132) comprises active and passive components, the high speed current limit (132) detects current through the device capacitive load (128) exceeding a predetermined threshold and limits the current back to the negative terminal of the first and second battery cell packs (108, 110).

9. The clamshell battery of claim 8, wherein the active components of the high speed current limit circuit (132) comprise a bank of series coupled transistors controlled by switching circuitry.

10. The clamshell battery of claim 1, wherein the third current limit circuit (122a) slows charging of the bulk capacitor (124) from forward current of second current loop (104), while the fourth unidirectional circuit (122b) provides fast discharging of the bulk capacitor (124) from forward current of the third current loop (106).

11. The clamshell battery of claim 1, wherein the first, second and third current loops (102, 104, 106) provide current flow in one direction along a unidirectional current path (130), the unidirectional current path (130) charging the bulk capacitor 124 and sourcing the device capacitive load (128) within current constraints which avoid sparking in a HazLoc environment.

12. The clamshell battery of claim 1, wherein the portable radio and clamshell battery are operable under both HazLoc and non-Hazloc environments.

13. The clamshell battery of claim 1, wherein the portable radio is a portable public safety radio.

14. The clamshell battery of claim 1, wherein the clamshell battery is integrated as part of a battery clamshell holder, the clamshell holder for coupling to the portable radio.
